(19) United States
(12) Patent Application Publication
(10) Pub. No.: US 2007/0030809 A1
(43) Pub. Date: Feb. 8, 2007

(54) System and method for multiple access and backhaul of a base station

(76) Inventor: Ashish K. Dayama, Aurora, IL (US)

Correspondence Address: Michael G. Fletcher;FLETCHER YODER, P.O. Box 692289, Houston, TX, 77269-2289, US

(21) Appl. No.: 11/199,046

(22) Filed: Aug. 8, 2005

(51) Int. Cl. H04L 12/26

(52) U.S. Cl. 370/237

(57) ABSTRACT

There is provided a system and method for multiple access and backhaul of a base station. More specifically, there is provided a method comprising detecting a decrease in throughput over a current backhaul, determining whether there is an alternate backhaul available, and accessing the alternate backhaul. There is also provided a base station comprising a first transceiver configured to communicate with at least one mobile device using a first wireless communication protocol, and a second transceiver communicatively coupled to the first transceiver and configured to communicate with the at least one mobile device using a second wireless communication protocol, wherein the first wireless communication protocol and the second wireless communication protocol are not compatible or backwards-compatible with each other irrespective of frequency.

### BACKGROUND OF THE INVENTION

1. Field of the Invention

The present invention relates generally to telecommunications and, more particularly, to wireless communications.

2. Description of the Related Art

This section is intended to introduce the reader to various aspects of art that may be related to various aspects of the present invention, which are described and claimed below. This discussion is believed to be helpful in providing the reader with background information to facilitate a better understanding of the various aspects of the present invention. Accordingly, it should be understood that these statements are to be read in this light, and not as admissions of prior art.

Over the past several decades, wireless communication technology and infrastructure have steadily evolved. Once, wireless telephones were considered an indulgence. Over the past few years, however, wireless telephones have become an integral part most people's lives. More than a mere convenience, wireless telephones are becoming the primary communication medium for an increasing percentage of the population. Indeed, recent initiatives, such as E-911, bear witness to the fact that in the near future, a significant number of people may rely on wireless telephones as their primary (and possibly only) access to the telephone system.

At the same time, wireless data devices, such as computers, personal digital assistants (“PDAs”), text pagers, and the like, have also become more popular. These wireless data devices may be configured to transmit and receive digital data, such as data files, pictures, videos, and so forth, over wireless telephone networks. Significantly, these wireless data devices may be configured to transmit and receive information from the Internet. Although many of these wireless data devices are still in their infancy, it is likely that in the next few years, an increasing number of people will begin to use wireless data devices as their primary conduit to the Internet.

For these reasons, one of the paramount challenges facing modern wireless communication providers is designing wireless communication systems that can satisfy this growing demand. These systems may be redundant enough to provide reliable service to those customers that depend on their wireless services and/or efficient enough to manage a large number of customers and/or data. Accordingly, more redundant and/or efficient wireless telecommunication systems would be desirable.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for multiple access and backhaul of a base station. More specifically, there is provided a method comprising detecting a decrease in throughput over a current backhaul, determining whether there is an alternate backhaul available, and accessing the alternate backhaul. There is also provided a base station comprising a first transceiver configured to communicate with at least one mobile device using a first wireless communication protocol, and a second transceiver communicatively coupled to the first transceiver and configured to communicate with the at least one mobile device using a second wireless communication protocol, wherein the first wireless communication protocol and the second wireless communication protocol are not compatible or backwards-compatible with each other irrespective of frequency.

### BRIEF DESCRIPTION OF THE DRAWINGS

Advantages of the invention may become apparent upon reading the following detailed description and upon reference to the drawings in which:

FIG. 1 illustrates a block diagram of an exemplary wireless telecommunication system in accordance with embodiments of the present invention;

FIG. 2 is a flowchart illustrating an exemplary technique for selecting a backhaul path in accordance with embodiments of the present invention; and

FIG. 3 is a flowchart illustrating an exemplary technique for selecting a wireless network in accordance with embodiments of the present invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions should be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described above, more redundant and/or efficient wireless telecommunication system are desirable. As such, several techniques for increasing the redundancy and/or efficiency of wireless telecommunication systems are described below. One technique is directed toward a base station that is configured to connect to a main switching center through two or more separate, redundant backhaul paths. Another technique is directed toward a base station that is configured to operate on two or more separate and distinct wireless communication protocols. Still another technique is directed towards a wireless device that is configured to detect a plurality of available wireless networks operating on two or more distinct wireless protocols, to rank the available networks and to select one of the available networks to use for wireless communication.

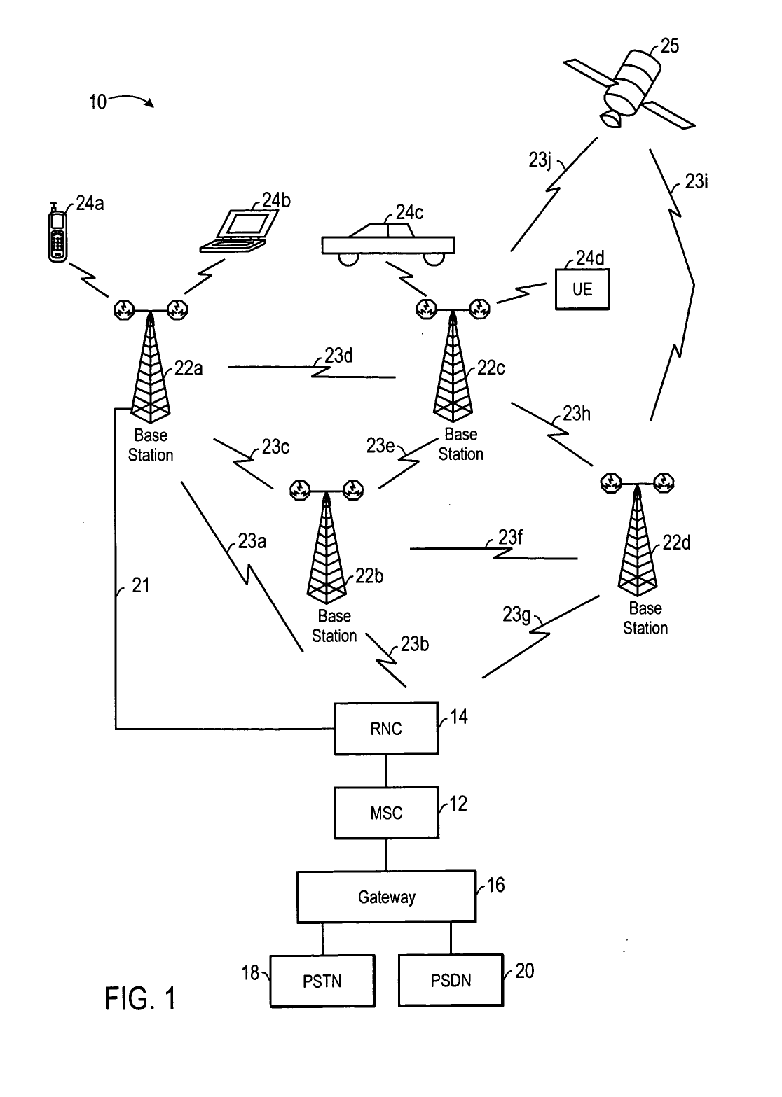

Turning now to the drawings and referring initially to FIG. 1, a block diagram of an exemplary wireless telecommunication system is illustrated and generally designated by a reference numeral 10. The wireless communication system 10 may include at least one mobile switching center (“MSC”) 12. The MSC 12 is a switch that serves the wireless communication system 10. The primary purpose of the MSC 12 may be configured to provide a voice path and/or a data path between a mobile device and another telephone or data source. The typical MSC 12 includes a number of devices, such as computerized call routers, that control switching functions, call processing, channel assignments, data interfaces, tracking, paging, call handoff, and user billing.

The MSC 12 may be coupled to a gateway 16, which in turn may be coupled to a public switched telephone network (“PSTN”) 18, which is often referred to as a land line telephone network. The wireless communication system 10 typically includes a connection to the PSTN 18, because a majority of all wireless telephone calls pass through the PSTN 18. The gateway 16 may also be coupled to a packet switch data network (“PSDN”) 20, such as the Internet, so as to provide Internet service to wireless telephone users.

One or more radio network controllers (“RNC”) 14 may also be coupled to the MSC 12. The RNC 14 may control the use and reliability of radio resources within the wireless communication system 10. Specifically, the RNC 14 may control the allocation and release of specific radio resources to establish a connection between the mobile devices (see below) and the MSC 12.

The RNC 14 may be communicatively coupled either by wire or wirelessly to one or more base stations 22a, 22b, 22c, and 22d. This connection between the base stations 24a, 24b, 24c, and 24d and the RNC 14, whether direct or through other base stations, repeaters, or satellites, is referred to as a backhaul. The base stations 22a, b, c, and d are transmission and reception stations that act as access points for a variety of mobile devices 24a, 24b, 24c, and 24d. The base stations 24a, 24b, 24c, and 24d receive data from the mobile devices 24a, 24b, 24c, and 24d and transmit the received data via a backhaul to the RNC 14, which subsequently transmits the received data to the MSC 12. Likewise, the RNC 14 may receive data intended for one of the mobile devices 24a, 24b, 24c, and 24d and may transmit this data via a backhaul to one of the base stations 22a, 22b, 22c, and 22d for transmission to the appropriate mobile device 24a, 24b, 24c, or 24d. As described further below, embodiments of the present technique are directed towards a system in which the base stations, such as 22a, have multiple backhauls.

As illustrated in FIG. 1, a backhaul may be formed from a physical connection 21, a wireless connection 23, or combination of the physical connection 21 and the wireless connection 23. Further, the backhaul may be direct connection between one of the base stations and the RNC 14, or the backhaul may include several intermediate “hops” from one base station to another and subsequently to the RNC 14. For example, one backhaul for the base station 22c includes the wireless connection 23e, the base station 22b, and the wireless connection 23b.

The physical connection 21 may employ Ethernet, gigabit Ethernet, T1, frame relay, fiber optics, or any other suitable physical connection protocol. While FIG. 1 illustrates only a single physical connection 21, in alternate embodiments, multiple physical connections 21 may be employed. The illustrated wireless connections 23a-23i may employ the I.E.E.E. 802.11 standard (a, b, g, n, and the like), the I.E.E.E. 802.16 standard (“WiMax”), Evolution Voice-Data Only (“EV-DO”), Universal Mobile Telecommunication System (“UMTS”), 1X Evolution Voice-Data Voice (“EV-DV”), Orthogonal Frequency Division Multiplexing (“OFDM”), or any other suitable wireless transmission protocol.

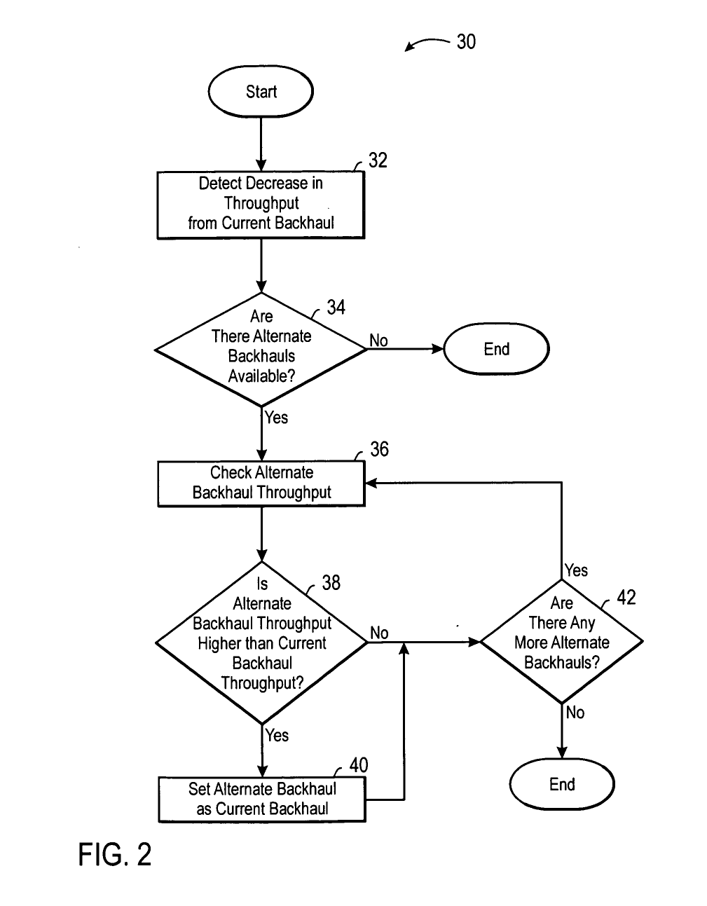

As described above, embodiments of the present technique may be directed towards a system in which the base stations 22a-22d can employ two or more separate redundant backhauls. For example, in FIG. 1, the base station 22a may be configured to communicate with the RNC 14 through a backhaul formed from the physical connection 21. Alternatively, the base station 22a may be configured to communicate with the RNC 14 via a backhaul formed from the wireless connection 23a or via a backhaul formed from the wireless connection 23c, the base station 22b, and the wireless connection 23b. As such, as will be described further below in regard to FIG. 2, the base stations 22a and 22b may each be able to utilize two or more separate and possibly redundant backhauls. In further example, the base station 22d may utilize a backhaul through the wireless connection 23f, the base station 22b, and the wireless connection 23b, or the base station 22d may utilize a direct backhaul to the RNC 14 via the wireless connection 23g. In addition, the base stations 22a-22d may also be configured to utilize a backhaul including an earth-orbiting satellite 25, which may be configured to communicate with either the RNC 14 or another one of the base stations 22a-22d.

Further, as illustrated in FIG. 1, the base stations 22a-22d may also be arranged to form a mesh network employing either a partial mesh topology or a full mesh topology. Those of ordinary skill in the art will appreciate that a mesh network is a network that employs one of two connection schemes: a full mesh topology or a partial mesh topology. In the full mesh topology, each node (e.g., base station) is connected directly to each of the other nodes. Whereas, in the partial mesh topology, some nodes are connected to all of the other nodes, but some of the nodes are connected to only a subset of the nodes. For example, in FIG. 1, the base stations 22a-22d are arrayed in a partial mesh topology, wherein each of the base stations 22a, 22c, and 22d are wirelessly coupled to the base station 22b.

As described above, the base stations 22a, 22b, 22c, and 22d may be communicatively coupled to the RNC 14 via two or more separate, redundant backhauls. As such, in the event of a failure or disruption of one backhaul, one of the base stations, 22a for example, can be transmit data to the RNC 14 via one of the alternate backhauls. Accordingly, FIG. 2 is a flowchart of an exemplary technique 30 that may employed by the base stations 22a, 22b, 22c, and 22d to select a backhaul path in accordance with one embodiment. As indicated by block 32, the technique 30 may begin with one of the base stations, 22a in this example, detecting a decrease in throughput along the current backhaul below a particular throughput threshold. In one embodiment, the throughput threshold may be programmed into the base station 22a. In alternate embodiments, the base station 22a may be configured to vary the throughput threshold based on call and/or data volume or RF conditions.

Once the base station 22a has detected the decrease in throughput over the current backhaul, it may determine whether there are alternate backhauls available, as indicated by block 34. If there are no other backhauls available, the technique 30 may end. If, however, there are alternate backhaul paths available, the base station 22a may check the throughput of one of the alternate backhauls, as indicated by block 36. Once the base station 22a has checked the throughput of the alternate backhaul, it may compare the throughput of the alternate backhaul to the throughput of the current backhaul (block 38). If the throughput of the alternate backhaul is higher (i.e., the alternate backhaul is better than the current backhaul), the base station 22a may set the alternate backhaul as the current backhaul for the base station 22a, as indicated by block 40.

On the other hand, if the alternate backhaul throughput was not higher than the current backhaul, the base station may determine whether there are any other unchecked backhauls, as indicated by block 42. If there are additional unchecked alternate backhauls, the base station 22a may repeat blocks 36-42 with one of the unchecked alternate backhauls. Similarly, even after setting the alternate backhaul as the current backhaul, the base station may continue to repeat blocks 36-42 with remaining unchecked alternated backhaul to select the backhaul with the highest throughput.

It will be appreciated, however, that the technique 30 is merely one example of a technique that the base stations 22a-22d may use to select a backhaul. In alternate embodiments, the base stations 22a-22d may employ a wide variety of suitable selection techniques. For example, in one embodiment, the base station 22a may select the first alternate backhaul that exceeds the throughput threshold without regard to which available backhaul might provide the highest throughput. In yet another embodiment, the base station 22a may be configured to employ multiple backhauls in a simultaneous or near simultaneous manner.

As described above, the base stations 22a, 22b, 22c, and 22d may be configured to act as reception and transmission station for the mobile devices 24a, 24b, 24c, and 24d. As such, another technique for improving the efficiency and/or redundancy of wireless communication is to configure the base stations, 22a in this example, to communicate with the mobile devices 24a-24d using a variety of distinct wireless communication protocols. As used herein, a wireless communication protocol is distinct from another wireless protocol if the two wireless protocols are not compatible or backwards-compatible with each other regardless of frequency or band. For example, GSM and UMTS are distinct wireless protocols because even if they were operating on the same frequency, a GSM device and a UMTS device cannot communicate with each other. However, GSM 850 MHz and GSM 1950 MHz are not distinct wireless communication protocols because a GSM 850 device could communicate with a GSM 1950 device if the GSM 850 device were reconfigured to operate at 1950 MHz or vice-versa.

Unlike conventional systems which may employ one wireless communication or one family of related (i.e., non-distinct) wireless communication protocols (e.g., CDMAone, CDMA2000, and EV-DO or Global System for Mobile Communications (“GSM”), WCDMA, and General Packet Radio Service (“GPRS”)), embodiments of the present system may employ multiple distinct wireless protocols. For example, the base stations 22a, 22b, 22c, and 22d may be configured to employ both 1xEv-DV and 802.11a; to employ UMTS, WiMax, and Flash OFDM; to employ both GSM and 802.11n; and so forth. In alternate embodiments, the base stations 22a, 22b, 22c, and 22d may also employ EV-DO, GPRS, WCDMA, TDMA, CDMAone, CDMA2000, or any other suitable wireless communication protocol. In one embodiment, each of the distinct wireless communication protocols are digital protocols.

In one embodiment, the base stations 22a, 22b, 22c, and 22d may contain a separate transceiver for each of the wireless communication protocols, whereas in another embodiment, the base stations 22a, 22b, 22c, and 22d may contain a single transceiver configured to operate on multiple wireless communication protocols. Moreover, the base stations 22a, 22b, 22c, and 22d may also employ one wireless communication protocol for shorter-range, higher bandwidth communication (e.g., 802.11, 802.16, or the like) and another wireless communication protocol for longer-range, lower bandwidth communications (e.g., 1xEV-DV, GSM, or the like).

As described above, the base stations 22a-22d may be configured to operate with multiple, distinct wireless protocols. As such, another technique for improving the efficiency and redundancy of wireless telecommunication may be to configure the mobile devices 22a-22d to operate on multiple distinct wireless communication protocols. Advantageously, this type of mobile device is able to communicate with a base station 22a-22d, as described above, or with multiple conventional base stations, each of which is operating with a distinct wireless communication protocol.

For example, the mobile devices 24a, 24b, 24c, and 24d may be configured to employ both 1xEv-DV and 802.11a or to employ UMTS, WiMax, and Flash OFDM or to employ GSM and 802.11n, and so forth. In alternate embodiments, the mobile devices 24a, 24b, 24c, and 24d may also employ additional combinations of the above-referenced wireless protocols as well as combinations including EV-DO, GPRS, WCDMA, TDMA, CDMAone, CDMA2000, or any other suitable wireless communication protocol. In one embodiment, the mobile devices 24a, 24b, 24c, and 24d may contain a separate transceiver for each of the wireless communication protocols, whereas in another embodiment, the mobile devices 24a, 24b, 24c, and 24d may contain a single transceiver configured to operate on multiple wireless communication protocols.

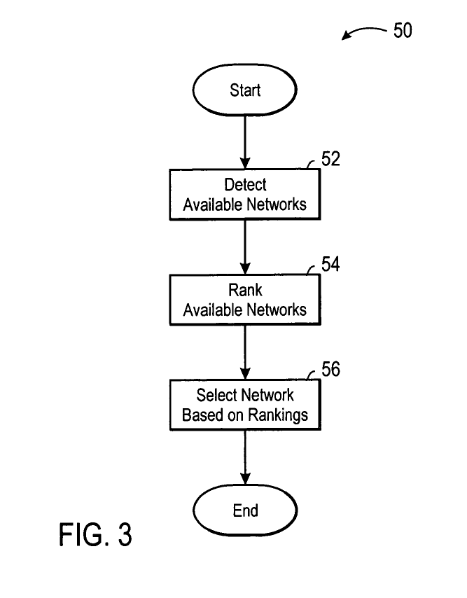

The mobile devices 24a, 24b, 24c, and 24d may be configured to identify available wireless communication protocols (i.e., identify the available wireless networks employing each of the wireless communication protocols) and the select one of the wireless networks. Accordingly, FIG. 3 is a flow chart illustrating an exemplary technique 50 that the mobile devices 24a, 24b, 24c, and 24d may employ for selecting a wireless network in accordance with one embodiment. As indicated by block 52, one of mobile devices 24a, 24b, 24c, or 24d may begin the technique 50 by detecting available networks. For example, if the mobile device 24a, 24b, 24c, or 24d is within range of an 802.11 network and a 1xEV-DV network, the mobile device 24a, 24b, 24c, 24d may detect the 802.11 network and the 1xEV-DV network.

After detecting the available networks, the mobile device 24a, 24b, 24c, or 24d may rank the available networks based on a predetermined metric, as indicated by block 54. In one embodiment, the mobile device 24a, 24b, 24c, or 24d may rank the available networks by bandwidth, throughput, or available data rate. In another embodiment, the mobile device 24a, 24b, 24c, or 24d may rank the available networks based on the strength of the signal being generated by the base station 22a, 22b, 22c, or 22d broadcasting the network connection. In yet another embodiment, the mobile device 24a, 24b, 24c, or 24d may rank the available networks by connection cost to a user. In still other embodiments, the mobile device 24a, 24b, 24c, or 24d may rank the available networks based on other suitable metrics.

Once the mobile device 24a, 24b, 24c, or 24d has ranked the available networks, it may select an available network to use for wireless communication, as indicated in block 56. In one embodiment, the mobile device 24a, 24b, 24c, or 24d may select the highest ranking network (e.g., the fastest network or the most inexpensive network). In alternate embodiments, the mobile device 24a, 24b, 24c, or 24d may select an available network based on another suitable ranking.

While the invention may be susceptible to various modifications and alternative forms, specific embodiments have been shown by way of example in the drawings and have been described in detail herein. However, it should be understood that the invention is not intended to be limited to the particular forms disclosed Rather, the invention is to cover all modifications, equivalents, and alternatives falling within the spirit and scope of the invention as defined by the following appended claims.

We claim:

1. A method for selecting a backhaul for a base station comprising:
detecting a decrease in throughput over a current backhaul;
determining whether there is a first alternate backhaul available; and
accessing the first alternate backhaul.

2. The method, as set forth in claim 1, comprising determining whether the alternate backhaul has higher throughput than the current backhaul.

3. The method, as set forth in claim 2, comprising setting the alternate backhaul as the current backhaul for the base station.

4. The method, as set forth in claim 2, comprising determining whether a second alternate backhaul is available if the throughput of the first alternate backhaul is not higher than the throughput of the current backhaul

5. The method, as set forth in claim 1, wherein detecting a decrease in throughput comprises detecting a decrease in throughput over a wireless backhaul.

6. A base station that communicates with at least one mobile device, the base station comprising:
a first transceiver configured to communicate with at least one mobile device using a first wireless communication protocol; and
a second transceiver communicatively coupled to the first transceiver and configured to communicate with the at least one mobile device using a second wireless communication protocol, wherein the first wireless communication protocol and the second wireless communication protocol are not compatible or backwards-compatible with each other irrespective of frequency.

7. The base station, as set forth in claim 6, wherein the first transceiver is configured to communicate using an I.E.E.E. 802.11 standard wireless communication protocol.

8. The base station, as set forth in claim 7, wherein the second transceiver is configured to communicate using an Evolution Voice-Date Voice wireless communication protocol.

9. The base station, as set forth in claim 7, wherein the second transceiver is configured to communicate using a GSM communication protocol.

10. The base station, as set forth in claim 6, wherein the first wireless communication protocol and the second wireless communication protocol are digital communication protocols.

11. The base station, as set forth in claim 6, wherein the first transceiver is configured to communicate using a WiMax standard wireless communication protocol and the second transceiver is configured to communicate using an Evolution Voice-Date Voice wireless communication protocol.

12. The base station, as set forth in claim 16, wherein the first transceiver is configured to communicate using an orthogonal frequency division multiplexing wireless communication protocol.

13. A mobile device configured to communicate with at least one base station, the mobile device comprising:
a first transceiver configured to communicate with at least one base station using a first wireless communication protocol; and
a second transceiver coupled to the first transceiver and configured to communicate with the at least one base station using a second wireless communication protocol, wherein the first wireless communication protocol and the second wireless communication protocol are not compatible or backwards-compatible with each other irrespective of frequency.

14. The mobile device, as set forth in claim 13, wherein the mobile device is configured to rank the first wireless communication protocol and the second wireless communication protocol based on a predetermined metric and to select one of the wireless communication protocols based on the ranking.

15. The mobile device, as set forth in claim 14, wherein the mobile device is configured to rank the wireless communication protocols based on a connection cost.

16. The mobile device, as set forth in claim 14, wherein the mobile device is configured to rank the wireless communication protocols based on a bandwidth supportable by the wireless communication protocols.

17. The mobile device, as set forth in claim 13, wherein the first transceiver is configured to communicate using an IEEE 802.11 wireless communication protocol.

18. The mobile device, as set forth in claim 13, wherein the first transceiver and the second transceiver are configured to communicate using a digital communication protocol.

19. The mobile device, as set forth in claim 13, comprising a third transceiver coupled to the first transceiver and the second transceiver, the third transceiver configured to communicate with the at least one base station using a third wireless communication protocol, wherein the first wireless communication protocol, the second wireless communication protocol, and the third wireless protocol are not compatible or backwards-compatible with each other irrespective of frequency.

20. The mobile device, as set forth in claim 19, wherein the first wireless protocol is an I.E.E.E. 802.11 standard wireless communication protocol.
